(19) United States
(12) Patent Application Publication
(10) Pub. No.: US 2018/0266892 A1
(43) Pub. Date: Sep. 20, 2018

(54) DEVICE FOR DETECTING AND LOGGING A TEMPERATURE OF A FLUID WHILE PLACED IN THE FLUID

(71) Applicant: Roche Diagnostics Operations, Inc., Indianapolis, IN (US)

(72) Inventors: Geza Burghardt, Uerzlikon (CH); Anthony Sibler, Birmensdorf (CH)

(73) Assignee: Roche Diagnostics Operations, Inc., Indianapolis, IN (US)

(21) Appl. No.: 15/913,296

(22) Filed: Mar. 6, 2018

(30) Foreign Application Priority Data
Mar. 20, 2017 (EP) 17161802.8

(51) Int. Cl. G01K 1/02; G01K 1/08

(52) U.S. Cl. CPC G01K 1/022; G01K 13/12; G01K 1/08; G01K 1/024

(57) ABSTRACT

A device for detecting and logging a temperature of a fluid while placed in the fluid is disclosed. The device comprises a microprocessor having an integrated temperature sensor. The temperature sensor is configured to detect the temperature of the fluid. The device also comprises a power source configured to power the microprocessor and a communication interface configured to be connected to an external read out device for enabling a read out of temperature data. A system and use of the device for detecting and logging a temperature of a fluid are also disclosed.

### CROSS-REFERENCE TO RELATED APPLICATIONS

This application claims the benefit of EP 17161802.8, filed Mar. 20, 2017, which is hereby incorporated by reference.

### BACKGROUND

The present disclosure relates to the field of handling of fluid samples and more particularly relates to a device for detecting and logging a temperature of a fluid while placed in the fluid, to a system comprising a read out device and such a device, and to a use of such a device for detecting and logging a temperature of a fluid while placed in the fluid.

In in-vitro diagnostics assays, it is often important to know that a fluid subject of an assay undergoes appropriate test conditions. One important information is for example the temperature of the fluid.

In order to detect the temperature, different types of temperature loggers are known. However, these temperature loggers involve drawbacks. Standard temperature loggers using wired sensors cause perturbation of the temperature in the fluid. Some of the sensors are too big for in-process surveillance in medical analyzers. Some sensors use infrared light. However, infrared sensors are neither specific nor accurate enough as they principally measure the temperature at the surface of a liquid.

Therefore, there is a need for device and system that allow detecting and logging the temperature of a fluid while placed in the fluid in a reliable and simplified manner.

### SUMMARY

According to the present disclosure, a device for detecting and logging a temperature of a fluid while placed in the fluid is presented. The device can comprise a microprocessor having an integrated temperature sensor. The temperature sensor can be configured to detect the temperature of the fluid. The device can also comprise a power source configured to power the microprocessor and a communication interface configured to be connected to an external read out device for enabling a read out of temperature data.

In accordance with one embodiment of the present disclosure, a system is also presented. The system can comprise a read out device and an above device. The read out device can be configured to be connected to the communication interface for enabling a read out of the temperature data.

In accordance with another embodiment of the present disclosure, a use of the above device for detecting and logging a temperature of a fluid. The use can comprise immersing at least one device in at least one respective fluid, powering the microprocessor by the power source, detecting the temperature of the at least one fluid by the integrated temperature sensor, and reading out the temperature data by an external read out device.

Accordingly, it is a feature of the embodiments of the present disclosure to provide for a device and system that allow detecting and logging the temperature of a fluid while placed in the fluid in a reliable and simplified manner. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a schematic view of a device for detecting and logging a temperature of a fluid according to an embodiment of the present disclosure.

FIG. 2 illustrates a schematic view of a system according to an embodiment of the present disclosure.

FIG. 3 illustrates the device immersed in the fluid according to an embodiment of the present disclosure.

FIG. 4 illustrates a schematic view of a further exemplary embodiment of the system according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

As used in the following, the terms “have”, “comprise” or “include” or any arbitrary grammatical variations thereof can be used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, notwithstanding the fact that the respective feature or element may be present once or more than once.

Further, as used in the following, the terms “particularly”, “more particularly”, “specifically”, “more specifically” or similar terms can be used in conjunction with additional/alternative features, without restricting alternative possibilities. Thus, features introduced by these terms can be additional/alternative features and may not be intended to restrict the scope of the claims in any way. The invention may, as the skilled person will recognize, be performed by using alternative features. Similarly, features introduced by “in an embodiment of the invention” or similar expressions can be intended to be additional/alternative features, without any restriction regarding alternative embodiments of the invention, without any restrictions regarding the scope of the invention and without any restriction regarding the possibility of combining the features introduced in such way with other additional/alternative or non-additional/alternative features of the invention.

The disclosed device for detecting and logging a temperature of a fluid while placed in the fluid can comprise a microprocessor having an integrated temperature sensor. The temperature sensor can be configured to detect the temperature of the fluid. The device can further comprise a power source configured to power the microprocessor. The device can further comprise a communication interface configured to be connected to an external read out device for enabling a read out of the temperature data.

The term “logging” as used in the art can refer to the operation of recording measurements at set intervals over a period of time. In this case, the measurements can be temperature measurements and the device can be also called a temperature logger.

Thus, the device may be put in contact, such as direct contact, with the fluid. For example, the device may be completely or at least in part immersed in the fluid or at the surface thereof. Further, in order to detect the temperature of the fluid, the temperature sensor inherent to the microprocessor, which is normally used to detect the temperature of the microprocessor, can be used which can allow miniaturization the device. Such a miniaturized device may be used in a broad range of applications such as verifying temperatures during the complete sample process of an instrument, checking the performance of incubators or during development, verification, quality control and the like. The device can reduce the time to check an instrument temperature regulation. The device can measure the temperature even in very small fluid volumes.

The term “microprocessor” as used herein can refer to a processor which can incorporate the functions of a central processing unit (CPU) on a single integrated circuit (IC), or at most a few integrated circuits. A processor can be an electronic circuit which can perform operations on some external data source, usually memory or some other data stream. The microprocessor can be a multipurpose, clock driven, register based, programmable electronic device which can accept digital or binary data as input, process it according to instructions stored in its memory, and provide results as output. Microprocessors can contain both combinational logic and sequential digital logic. Microprocessors can operate on numbers and symbols represented in the binary numeral system. The integration of a whole CPU onto a single chip or on a few chips can greatly reduce the cost of processing power, increasing efficiency.

The term “integrated temperature sensor” as used herein can refer to the temperature sensor integrated with or inherent to the microprocessor. The reason for the provision of a microprocessor with an integrated temperature sensor is that such processors may not exceed the operation temperatures similar to semiconductors as such exceeding may cause malfunctions such as crashes or even destroy the chip in worst cases. In order to check the temperature, a temperature sensor can be provided and integrated into the processor.

The term “power source” as used herein can refer to any device configured to supply electric power or current to the microprocessor.

The term “communication interface” as used herein can refer to an interface configured to send data over a communication channel or computer bus. The data may be sent one bit at a time, i.e. sequentially, or as a whole, i.e. in parallel, on a link with several parallel channels. An interface can be a shared boundary across which two separate components of a computer based system exchange information. The exchange can be between software, computer hardware, peripheral devices, humans and combinations of these.

The term “read out device” as used herein can refer to any device configure to take or retrieve data from the microprocessor.

The microprocessor may further comprise an integrated storage device configured to at least temporarily store temperature data detected by the temperature sensor. Thus, the temperature data may first be stored and then retrieved at an appropriate point of time. This can be particularly relevant when access to the temperature data is not possible in real time.

The device may further comprise a waterproof housing, wherein the microprocessor, the power source and the communication interface can be arranged within the housing. Thus, the device may not only be formed in a compact manner but may also be completely immersed into the fluid which can improve the quality of the temperature detection. Needless to say, the storage device may also be located within the housing.

The housing may be a three dimensional body, wherein each of the dimensions of the body is can be smaller than 5.0 mm and, in another embodiment, smaller than 4.5 mm and in yet another embodiment, smaller than 4.0 mm. Thus, the device may be designed rather or comparably small.

The temperature sensor may be configured to detect the temperature of the sample fluid at predetermined periods. Thus, the data volume and the energy consumption of the microprocessor may be reduced if the temperature data are not continuously created. This can be particularly advantageous for temperature detection with fluid whose temperature does not vary rapidly.

The periods may be variable from 60 s to 0.5 s and, in another embodiment, 30 s to 1.0 s. Thus, the frequency of temperature detection may be adjusted to the respective application. For example, the periods may be continuously variable or may be variable at predetermined steps. Thus, the periods may be individually adjusted.

The temperature sensor may be calibrated so as to comprise an accuracy of ±0.25 K or less, in another embodiment, ±0.20 K or less and, in yet another embodiment, ±0.15 K or less. Thus, the accuracy of the temperature sensor can be sufficient for most applications.

The power source may be a battery, a rechargeable battery and/or a capacitor. Thus, the power source may be selected from a large group of commercially available constructional members and the exact power source may be adapted to the respective application.

The temperature sensor may be configured to detect temperatures in a range from −20° C. to 140° C. and, in another embodiment, −10° C. to 120°. Thus, the device may be used to detect temperatures of fluids used in most analytical processes.

The communication interface may be configured to be plugged to the external read out device or to an adapter of the external read out device or to be wireless connected to the external read out device for enabling a read out of the temperature data. Thus, data retrieval can be in many different ways.

The communication interface may be configured to enable a real time read out of the temperature data. Thus, temperature control of the fluid can be enabled in real time which can facilitate the handling of the fluid. For this purpose, the communication interface may comprise a radio frequency (RF) chip.

The disclosed system can comprise a read out device and a device as described above. The read out device can be configured to be connected to the communication interface for enabling a read out of the temperature data.

The read out device can enable temperature data retrieval. This data may be processed and used for a temperature control of the fluid.

The disclosed system can further comprise an instrument for processing a plurality of fluids and a plurality of devices as described above. The devices can be configured to be placed in at least some of the plurality of fluids. Thus, temperatures may be detected at several strategic important positions. For example, several devices may be used for testing the homogeneity of a multiwell-plate during cycling.

The term “instrument” as used herein can refer to any apparatus or apparatus component operable to execute one or more processing steps/workflow steps on one or more biological samples and/or one or more reagents. The expression ‘processing steps’ thereby can refer to physically executed processing steps such as centrifugation, aliquoting, sample analysis and the like. The term ‘instrument’ can cover pre-analytical instruments, post-analytical instruments and also analytical instruments. Thus, the term “instrument” can be used synonymous with the term “laboratory instrument”.

The term ‘analyzer’/‘analytical instrument’ as used herein can encompass any apparatus or apparatus component configured to obtain a measurement value. An analyzer can be operable to determine via various chemical, biological, physical, optical or other technical procedures a parameter value of the sample or a component thereof. An analyzer may be operable to measure the parameter of the sample or of at least one analyte and return the obtained measurement value. The list of possible analysis results returned by the analyzer can comprise, without limitation, concentrations of the analyte in the sample, a digital (yes or no) result indicating the existence of the analyte in the sample (corresponding to a concentration above the detection level), optical parameters, DNA or RNA sequences, data obtained from mass spectroscopy of proteins or metabolites and physical or chemical parameters of various types. An analytical instrument may comprise units assisting with the pipetting, dosing, and mixing of samples and/or reagents. The analyzer may comprise a reagent holding unit for holding reagents to perform the assays.

Reagents may be arranged, for example, in the form of containers or cassettes containing individual reagents or group of reagents, placed in appropriate receptacles or positions within a storage compartment or conveyor. It may comprise a consumable feeding unit. The analyzer may comprise a process and detection system whose workflow can be optimized for certain types of analysis. Examples of such analyzer are clinical chemistry analyzers, coagulation chemistry analyzers, immunochemistry analyzers, urine analyzers, nucleic acid analyzers, used to detect the result of chemical or biological reactions or to monitor the progress of chemical or biological reactions.

The system may further comprise one or more temperature regulating units and a controller communicating with the read out device configured to control, such as in order to adjust the temperature, the one or more temperature regulating units based on the temperature data.

The disclosed use of a device as described above for detecting and logging a temperature of a fluid can comprise immersing at least one device in at least one respective fluid, powering the microprocessor by the power source, detecting the temperature of the at least one fluid by the integrated temperature sensor, and reading out the temperature data by an external read out device.

The device may be removed from the sample fluid and the temperature data may be subsequently read out. For this purpose, the device may be plugged to the external read out device. Alternatively, the temperature data may be read out while the devise is placed in the fluid. In the latter case, the temperature data may be read out in real time. Thus, temperature control of the fluid can be enabled in real time which facilitates the handling of the fluid. For this purpose, the communication interface may comprise an RF chip.

The at least one fluid may be processed by an instrument for processing a fluid. The temperature of the fluid may be detected while the at least one fluid is processed. Processing of the at least one fluid can include any one or more of cooling, heating, preparing, analyzing, reacting and/or cycling the fluid. Thus, the temperature control of the fluid can be enabled throughout and continuously during processing of the fluid.

Further, logged temperature data may be compared with target temperature values to perform a quality control of an instrument, e.g. by comparing measured temperature values with expected or theoretical temperature values, e.g. temperature profiles, according to specification, thereby determining an operation qualification and performance qualification of the instrument.

Further, one or more temperature regulating units may be controlled based on the temperature data read by the read out device in order to adjust the temperature for processing the at least one fluid. For example, with this approach, temperature homogeneity across a plurality of fluids may be established or re-established, or this approach can be used generally to assure optimal processing temperature for one or more fluids. The adjustment and/or verification can be real time or before or after sample processing. This can be done once, e.g. at instrument manufacturing, e.g. for calibration purpose, or at regular intervals by service engineer or by a user, or in real time.

The term “multiwell plate” as used herein can refer to a flat plate with multiple “wells” used as small test tubes. Such a multiwell plate can also be known as microtiter plate. The microplate has become a standard tool in analytical research and clinical diagnostic testing laboratories. A very common usage is in the enzyme-linked immunosorbent assay (ELISA), the basis of most modern medical diagnostic testing in humans and animals. A multiwell plate typically has 6, 24, 96, 384 or 1536 sample wells arranged in a 2:3 rectangular matrix. Some microplates have even been manufactured with 3456 or 9600 wells, and an “array tape” product has been developed that provides a continuous strip of microplates embossed on a flexible plastic tape. Each well of a microplate can typically hold somewhere between tens of picolitres to several millilitres of liquid. They can also be used to store dry powder or as racks to support glass tube inserts. Wells can be either circular or square. For compound storage applications, square wells with close fitting silicone cap-mats are preferred. Microplates can be stored at low temperatures for long periods, may be heated to increase the rate of solvent evaporation from their wells and can even be heat-sealed with foil or clear film. Microplates with an embedded layer of filter material were also developed, and today, there are microplates for just about every application in life science research which involves filtration, separation, optical detection, storage, reaction mixing, cell culture and detection of antimicrobial activity.

A device for detecting and logging a temperature of a fluid while placed in the fluid is presented. The device can comprise a microprocessor having an integrated temperature sensor.

The temperature sensor can be configured to detect the temperature of the fluid. The device can also comprise a power source configured to power the microprocessor and a communication interface configured to be connected to an external read out device for enabling a read out of the temperature data.

The microprocessor can further comprise an integrated storage device configured to at least temporarily store temperature data detected by the temperature sensor.

The device can further comprise a waterproof housing. The microprocessor, the power source, and the communication interface can be arranged within the housing. The housing can be a three dimensional body. Each of the dimensions of the body can be smaller than 5.0 mm and, in one embodiment can be smaller than 4.5 mm and, in yet another embodiment, smaller than 4.0 mm.

The temperature sensor can be configured to detect the temperature of the fluid at predetermined periods. The periods can be variable from 60 s to 0.5 s and, in another embodiment, the periods can be variable from 30 s to 1.0 s. The periods can be continuously variable or can be at predetermined steps variable.

The temperature sensor can be calibrated so as to comprise an accuracy, in one embodiment, of ±0.25 K or less and, in another embodiment, ±0.20 K or less and, in yet another embodiment, ±0.15 K or less.

The power source can be a battery, a rechargeable battery and/or a capacitor.

The temperature sensor can be configured to detect temperatures in a range from, in one embodiment, −20° C. to 140° C. and, in another embodiment, −10° C. to 120°.

The communication interface can be configured to be plugged to the external read out device or to an adapter of the external read out device or to be wireless connected to the external read out device for enabling a read out of the temperature data. The communication interface can be configured to enable a real time read out of the temperature data. The communication interface can comprise an RF chip.

A system comprising a read out device and an above device is presented. The read out device can be configured to be connected to the communication interface for enabling a read out of the temperature data.

A system comprising an instrument for processing a plurality of fluids and a plurality of above devices is also presented. The devices can be configured to be placed in at least some of the plurality of fluids.

The system can further comprise one or more temperature regulating units and a controller communicating with the read out device configured to control the one or more temperature regulating units based on the temperature data.

A use of an above device for detecting and logging a temperature of a fluid is presented. The use can comprise immersing at least one device in at least one respective fluid, powering the microprocessor by the power source, detecting the temperature of the at least one fluid the integrated temperature sensor, and reading out the temperature data by an external read out device.

The use can further comprise storing at least temporarily the temperature data in the storage device.

The use can further comprise removing the device from the sample fluid and subsequently reading out the temperature data. The use can further comprise plugging the device to the external device.

The use can further comprise reading out the temperature data while the device is placed in the fluid. The use can further comprise reading out the data in real time.

The use can further comprise processing the at least one fluid by an instrument for processing a fluid and detecting the temperature of the fluid while the at least one fluid is processed. Processing of the at least one fluid can include any one or more of cooling, heating, mixing, preparing, analyzing, reacting and/or cycling the fluid.

The use can further comprise comparing the logged temperature with target temperature values to perform a quality control of an instrument.

The use can further comprise controlling one or more temperature regulating units based on the temperature data read by the read out device in order to adjust the temperature for processing the at least one fluid.

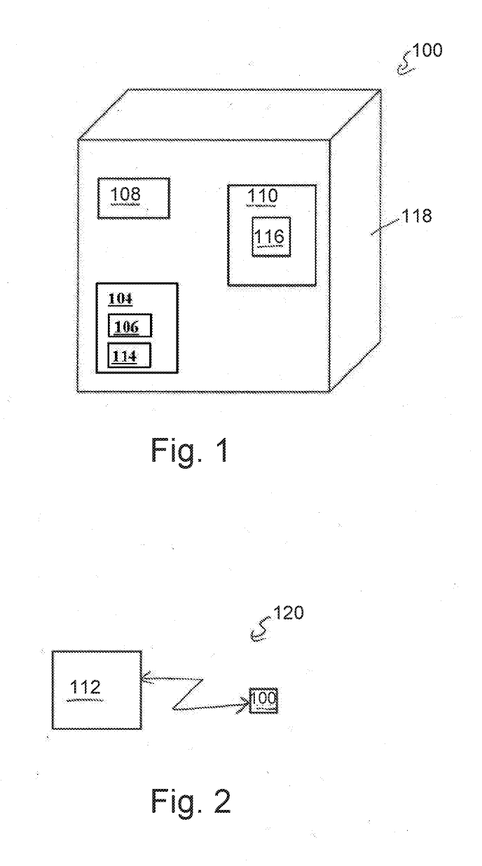

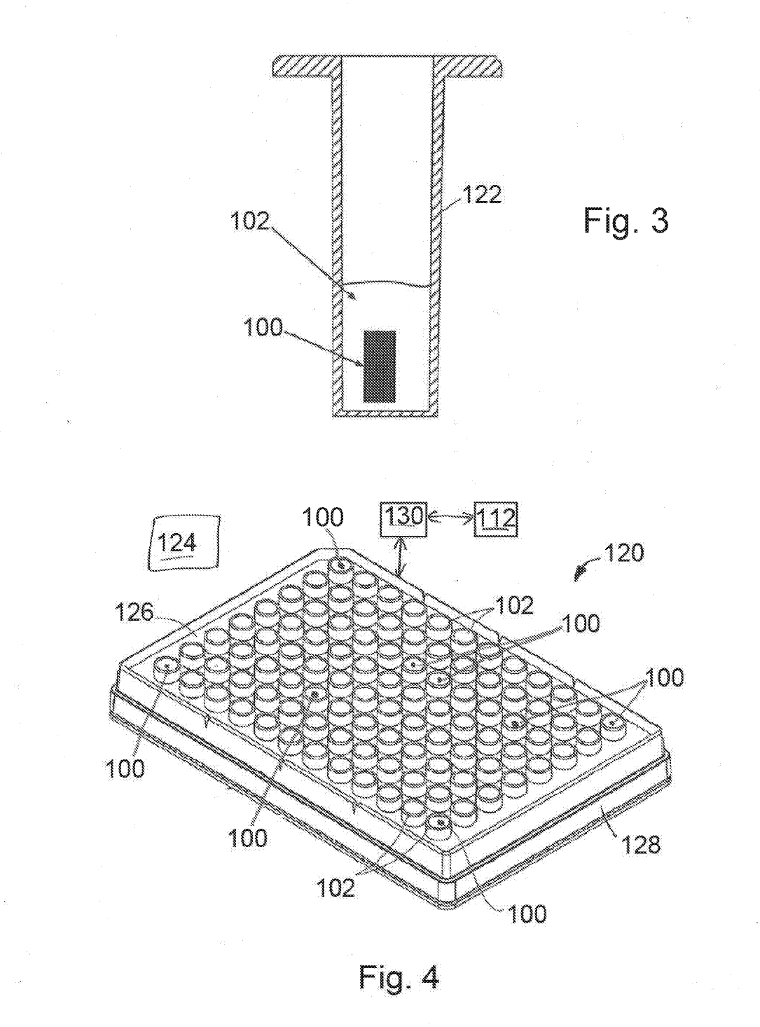

Referring initially to FIG. 1, FIG. 1 shows a schematic view of a device 100 for detecting and logging a temperature of a fluid 102. The device 100 can be configured to detect a temperature of the fluid 102 while placed in the fluid 102 (FIG. 3). The device 100 can comprise a microprocessor 104. The microprocessor 104 can comprise a temperature sensor 106 integrated therewith, i.e. an integrated temperature sensor. The temperature sensor 106 can be configured to detect the temperature of the fluid 102. The temperature sensor 106 can be configured to detect temperatures in a range, in one embodiment, from −20° C. to 140° C. and, in another embodiment, −10° C. to 120° . The temperature sensor 106 can be calibrated so as to comprise an accuracy, in one embodiment, of ±0.25 K or less, in another embodiment, ±0.20 K or less and, in yet another embodiment, ±0.15 K or less. Particularly, the temperature sensor 106 can be configured to detect the temperature of the fluid 102 at predetermined periods. The periods are variable, in one embodiment, from 60 s to 0.5 s and, in another embodiment, 30 s to 1.0 s. The periods can be continuously variable. Alternatively, the periods can be variable at predetermined steps.

The device 100 can further comprise a power source 108 configured to power the microprocessor 104. The power source 108 can be a battery, a rechargeable battery and/or a capacitor. In the embodiment shown in FIG. 1, the power source 108 can be a capacitor. The capacitor can have a capacity sufficient to power the microprocessor for, in one embodiment, at least 30 minutes and, in another embodiment, at least 50 minutes.

The device 100 can further comprise a communication interface 110 configured to be connected to an external read out device 112 (FIG. 2) for enabling a read out of the temperature data. The temperature data can be provided by the temperature sensor 106. The microprocessor 104 can further comprise a storage device 114 integrated therewith and configured to at least temporarily store temperature data detected by the temperature sensor 106. For enabling a read out of the temperature data, the communication interface 110 can be configured to be plugged to the external read out device 112. In addition, or alternatively, the communication interface 110 can be configured to be plugged to an adapter of the external read out device 112 or to be wireless connected to the external read out device 112. The communication interface 110 may be configured to enable a real time read out of the temperature data. For example, the communication interface 110 may comprise an RF chip 116. Such a RF chip 116 can allow continuously retrieval of the temperature data by a corresponding antenna. Thus, the read out device 112 may retrieve the temperature data directly from the microprocessor 104. The power source 108 can be recharged for example via the communication interface 110, e.g. when plugged to the readout device 112, or via RF-Chip, or by induction.

The device 100 can further comprise a waterproof housing 118. The microprocessor 104, the power source 108, the communication interface 110 and the storage device 114 can be arranged within the housing 118. Thus, all of these components can be protected from liquids such as water. This arrangement can allow the device 100 to detect a temperature of the fluid 102 while placed in the fluid 102. The housing 118 can be a three dimensional body. Each of the three dimensions of the body can be, in one embodiment, smaller than 5.0 mm, in another embodiment, smaller than 4.5 mm, and, in yet another embodiment, smaller than 4.0 mm. In other words, each of the length, width and height of the housing 118 may not be larger than 5.0 mm in one embodiment, 4.5 mm in another embodiment, and 4.0 mm, in yet another embodiment.

FIG. 2 shows a schematic view of a system 120. The device 100 may be part of the system 120. The system 120 can further comprise the read out device 112. The read out device 112 can be configured to be connected to the communication interface 110 of the device 100 for enabling a read out of the temperature data. For this purpose, the communication interface 110 may be plugged to the read out device 112 or to an adapter of the read out device 112 or may be wireless connected to the read out device 112.

The device 100 may be used to detect a temperature of a fluid 102 while placed in the fluid 102 as will be explained in further detail below. For this purpose, the device 100 can be immersed in the fluid 102.

FIG. 3 shows the device 100 immersed in the fluid 102. For example, the fluid 102 can be a liquid sample provided in a cuvette 122. Needless to say, the fluid 102 may be any kind of fluid and may be provided in another or different container such as a reagent vessel, sample vessel, sample tube and the like. While immersed in the fluid 102, the power source 108 can power the microprocessor 104 and the integrated temperature sensor 106 can detect the temperature of the fluid 102.

The temperature data thus acquired can be read out by the read out device 112. Particularly, the device 100 can be removed from the fluid 102 and the temperature data can be subsequently read out. For this purpose, the device 100 can be plugged to the read out device 112 by the communication interface 110. In addition, or alternatively, the temperature data may be read out while the device 100 is placed in the fluid 102. For example, the temperature data may be read out in real time by the RF chip 116 of the communication interface 110 and a corresponding antenna from the read out device 112.

FIG. 4 shows a schematic view of a further exemplary embodiment of the system 120. Hereinafter, only the differences from the system 120 according to the previous embodiment are described and like constructional members are indicated by like reference numerals. As shown in FIG. 4, the system 120 can further comprise an instrument 124 for processing a plurality of fluids 102 and a plurality of devices 100 as described before. The fluids 102 may be provided in a multiwell plate 126. Needless to say, the fluids 102 may be provided in many different ways such as in a rack supporting a plurality of sample tubes. The devices 100 can be configured to be placed in at least some of the plurality of fluids 102. The system 120 can further comprise one or more temperature regulating units 128 and a controller 130 configured to communicate with the read out device 112. The controller 130 can be configured to control the one or more temperature regulating units 128 based on the temperature data retrieved by the read out device 112. Thus, the system 120 can be configured to adjust the temperature of the fluids 102.

With this arrangement, it can be possible to process the at least one fluid 102 by the instrument 124 and to detect the temperature of the fluid 102 while the at least one fluid 102 is processed. Processing of the at least one fluid 102 can include any one or more of cooling, heating, preparing, analyzing, reacting and/or cycling the fluid 102. Further, it can be possible to compare the logged temperature with target temperature values, such as saved temperature profiles, to perform a quality control of an instrument 124.

Further, the one or more temperature regulating units 128 can be controlled based on the temperature data read by the read out device 112 in order to adjust the temperature for processing the at least one fluid 102. Thus, it can be possible to establish, or re-establish, temperature homogeneity across a plurality of fluids 102, or generally to assure optimal processing temperature for one or more fluids 102. The adjustment can be real time or after sample processing. This can be done once, e.g. at instrument manufacturing, or at regular intervals by service engineer or by user, or real time.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A device for detecting and logging a temperature of a fluid while placed in the fluid, the device comprising:
a microprocessor having an integrated temperature sensor, wherein the temperature sensor is configured to detect the temperature of the fluid;
a power source configured to power the microprocessor; and
a communication interface configured to be connected to an external read out device for enabling a read out of temperature data.

2. The device according to claim 1, wherein the microprocessor further comprising an integrated storage device configured to at least temporarily store temperature data detected by the temperature sensor.

3. The device according to claim 1, further comprising,
a waterproof housing, wherein the microprocessor, the power source, and the communication interface are arranged within the housing.

4. The device according to claim 3, wherein the housing is a three dimensional body, wherein each of the dimensions of the body is smaller than 5.0 mm.

5. The device according to claim 3, wherein the housing is a three dimensional body, wherein each of the dimensions of the body is smaller than 4.5 mm.

6. The device according to claim 3, wherein the housing is a three dimensional body, wherein each of the dimensions of the body is smaller than 4.0 mm.

7. The device according to claim 1, wherein the temperature sensor is calibrated so as to comprise an accuracy of ±0.25 K or less.

8. The device according to claim 1, wherein the temperature sensor is calibrated so as to comprise an accuracy of ±0.20 K or less.

9. The device according to claim 1, wherein the temperature sensor is calibrated so as to comprise an accuracy of ±0.15 K or less.

10. The device according to claim 1, wherein the temperature sensor is configured to detect temperatures in a range from −20° C. to 140° C.

11. The device according to claim 1, wherein the temperature sensor is configured to detect temperatures in a range from −10° C. to 120°.

12. The device according to claim 1, wherein the communication interface is configured to be plugged to the external read out device or to an adapter of the external read out device or to be wireless connected to the external read out device for enabling a read out of the temperature data and/or for recharging the power source.

13. The device according to claim 1, wherein the communication interface is configured to enable a real time read out of the temperature data.

14. A system, the system comprising:
a read out device; and
a device according to claim 1, wherein the read out device is configured to be connected to the communication interface for enabling a read out of the temperature data.

15. The system according to claim 14, further comprising,
an instrument for processing a plurality of fluids and a plurality of devices according to claim 1, wherein the devices are configured to be placed in at least some of the plurality of fluids.

16. The system according to claim 14, further comprising,
one or more temperature regulating units; and
a controller communicating with the read out device configured to control the one or more temperature regulating units based on the temperature data.

17. A use of a device according to claim 1 for detecting and logging a temperature of a fluid, the use comprising:
immersing at least one device in at least one respective fluid;
powering the microprocessor by the power source;
detecting the temperature of the at least one fluid by the integrated temperature sensor; and
reading out the temperature data by an external read out device.

18. The use according to claim 17, further comprising,
processing the at least one fluid by an instrument for processing a fluid; and
detecting and logging the temperature of the fluid while the at least one fluid is processed, wherein processing of the at least one fluid includes any one or more of cooling, heating, preparing, analyzing, reacting and/or cycling the fluid.

19. The use according to claim 17, further comprising,
comparing the logged temperature with target temperature values to perform a quality control of an instrument.

20. The use according to claim 17, further comprising,
controlling one or more temperature regulating units based on the temperature data read by the read out device in order to adjust the temperature for processing the at least one fluid.
